(19) United States
(12) Patent Application Publication
(10) Pub. No.: US 2026/0166576 A1
(43) Pub. Date: Jun. 18, 2026

(54) PRESSURE WASHING APPARATUS

(71) Applicant: Nanjing Chervon Industry Co., Ltd., Nanjing (CN)

(72) Inventors: Bowei Xu, Nanjing (CN); Pengpeng Cao, Nanjing (CN); Yang Gu, Nanjing (CN)

(21) Appl. No.: 19/074,934

(22) Filed: Mar. 10, 2025

(30) Foreign Application Priority Data
Dec. 16, 2024 (CN) 202411858449.1
Dec. 16, 2024 (CN) 202411858721.6

(51) Int. Cl. B05B 9/04; B05B 9/08

(52) U.S. Cl. CPC B05B 9/0403; B05B 9/0861

(57) ABSTRACT

A pressure washing apparatus includes a body and a spray gun connectable to the body; where the body includes a housing; a power unit located in the housing and including an electric motor for making the spray gun spray a liquid; a power supply device including at least one battery pack to power the electric motor; and a grip for a user to hold to carry and move the pressure washing apparatus. When the pressure washing apparatus is in operation, a maximum value of a product of pressure and a flow rate of the liquid sprayed from the spray gun is greater than or equal to 2000 PSI·GPM; and the volume of the body is less than or equal to 0.032 m³.

### RELATED APPLICATION INFORMATION

This application claims the benefit under 35 U.S.C. § 119(a) of Chinese Patent Application No. CN 202411858721.6, filed on Dec. 16, 2024, and Chinese Patent Application No. CN 202411858449.1 filed on Dec. 16, 2024, which applications are incorporated herein by reference in their entireties.

### BACKGROUND

A pressure washer is a machine that uses a power device to drive a high-pressure plunger pump to generate high-pressure water and sprays the high-pressure water through a spray gun to wash the surface of an object. The pressure washer can peel off and wash away dirt to achieve the purpose of cleaning the surface of the object.

A washing apparatus in the related art is relatively large in volume and is difficult to carry and store. The pressure and flow rate that a spray gun of the washing apparatus can provide are related to the energy of a battery pack, the power of a booster pump, and other factors. Therefore, as the pressure and flow rate increase, the overall volume increases.

This part provides background information related to the present application, and the background information is not necessarily the existing art.

### SUMMARY

A pressure washing apparatus includes a body and a spray gun connectable to the body. The body includes a housing; a power unit located in the housing and including an electric motor for making the spray gun spray a liquid; a power supply device including at least one battery pack to power the electric motor; and a grip for a user to hold to carry and move the pressure washing apparatus. When the pressure washing apparatus is in operation, a maximum value of a product of pressure and a flow rate of the liquid sprayed from the spray gun is greater than or equal to 2000 PSI·GPM. The volume of the body is less than or equal to 0.032 m³.

In some examples, the maximum value of the product of the pressure and the flow rate of the liquid sprayed from the spray gun is greater than or equal to 2500 PSI·GPM.

In some examples, the volume of the body is less than or equal to 0.03 m³.

In some examples, the pressure of the liquid sprayed from the spray gun is 1000 PSI to 2000 PSI.

In some examples, the flow rate of the liquid sprayed from the spray gun is 0.9 GPM to 2.0 GPM.

In some examples, the grip is disposed at the top of the housing and extends along a long side of the top of the housing, and the grip extends from an end of the housing to the other end of the housing.

In some examples, the length of the body is 30 cm to 38 cm.

In some examples, the height of the body is 32 cm to 38 cm.

In some examples, the width of the body is 23 cm to 28 cm.

In some examples, the at least one battery pack is detachably inserted into the housing, and the rated voltage of each of the at least one battery pack is 20 V to 60 V.

In some examples, when the product of the pressure and the flow rate of the liquid sprayed from the spray gun has the maximum value, a battery life of the at least one battery pack with a capacity of 336 W·h is greater than or equal to 10 minutes.

In some examples, the pressure washing apparatus further includes a liquid tank, the housing has a water inlet, and the liquid tank is disposed outside the housing and supplies water to the spray gun through the water inlet.

In some examples, the body further includes a circuit board assembly, the housing is provided with an air inlet and an air outlet, a heat dissipation air path for guiding an airflow to flow from the air inlet to the air outlet is formed in the housing, and the circuit board assembly is disposed in the housing and located on an airflow path of the heat dissipation air path.

In some examples, the circuit board assembly is disposed close to the air inlet, and the airflow entering from the air inlet flows through the circuit board assembly and the electric motor in sequence and then flows out from the air outlet.

In some examples, the power unit further includes a booster pump connected to the electric motor, and the electric motor drives the booster pump to operate to make the spray gun spray a high-pressure liquid.

A pressure washing apparatus includes a body and a spray gun connectable to the body. The body includes a housing; a power unit located in the housing and including an electric motor for making the spray gun spray a liquid; a power supply device including at least one battery pack to power the electric motor; and a grip for a user to hold to carry and move the pressure washing apparatus. When the pressure washing apparatus is in operation, a maximum value of a product of pressure and a flow rate of the liquid sprayed from the spray gun is greater than or equal to 2000 PSI·GPM. The height of the body is less than or equal to 40 cm.

In some examples, the height of the body is less than or equal to 38 cm.

In some examples, after the at least one battery pack is detached, the weight of the body is less than or equal to 8 kg.

In some examples, the maximum value of the product of the pressure and the flow rate of the liquid sprayed from the spray gun is greater than or equal to 2500 PSI·GPM.

In some examples, the grip is disposed at the top of the housing and extends along a long side of the top of the housing, and the grip extends from an end of the housing to the other end of the housing.

In some examples, the length of the body is 30 cm to 38 cm.

In some examples, the width of the body is 23 cm to 28 cm.

In some examples, the at least one battery pack is detachably inserted into the housing, and the angle α between a direction in which the at least one battery pack is inserted and removed and a horizontal or vertical plane is less than or equal to 30°.

A pressure washing apparatus includes a body and a spray gun connectable to the body. The body includes a housing; a power unit located in the housing and including an electric motor for making the spray gun spray a liquid; and a power supply device including at least one battery pack to power the electric motor. When the pressure washing apparatus is in operation, a maximum value of a product of pressure and a flow rate of the liquid sprayed from the spray gun is greater than or equal to 2000 PSI·GPM. The housing is formed with or connected to a grip for a user to hold to carry and move the pressure washing apparatus. In a height direction, the distance from the grip center of the grip to the center of gravity of the body is less than or equal to 30 cm. In some examples, the distance from the grip center of the grip to the center of gravity of the body is less than or equal to 28 cm.

In some examples, an effective grip length of the grip is greater than or equal to 10 cm.

In some examples, the grip is disposed at the top of the housing and extends along a long side of the top of the housing, and the grip extends from an end of the housing to the other end of the housing.

In some examples, the at least one battery pack is detachably inserted into the housing, the center of gravity of the body is a first center of gravity after the at least one battery pack is inserted, and the center of gravity of the body is a second center of gravity after the at least one battery pack is removed, where the distance between the first center of gravity and the second center of gravity is less than or equal to 2 cm.

### BRIEF DESCRIPTION OF THE DRAWINGS

FIG. 1 is a first structural view of a pressure washing apparatus of the present application.

FIG. 2 is a second structural view of the pressure washing apparatus of the present application.

FIG. 3 is a structural view of a body of the present application.

FIG. 4 is a front view of the body of the present application.

FIG. 5 is a side view of the body of the present application.

FIG. 6 is a sectional view of the body of the present application.

FIG. 7 is an exploded view of the body of the present application.

FIG. 8 is a structural view of a first housing of the pressure washing apparatus of the present application.

FIG. 9 is a structural view of a second housing of the pressure washing apparatus of the present application.

FIG. 10 is a structural view of the pressure washing apparatus of the present application with a housing omitted.

FIG. 11 is a partial structural view of the pressure washing apparatus of the present application.

FIG. 12 is a partial structural view of the pressure washing apparatus of the present application with a battery pack detached.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

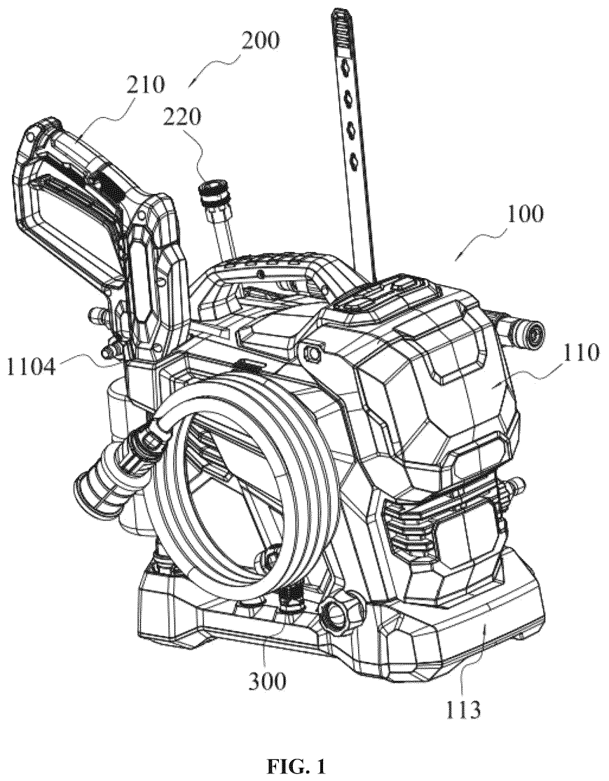

Referring to FIGS. 1 to 3, the present application provides a pressure washing apparatus including a body 100 and a spray gun 200 connectable to the body 100. The spray gun 200 is detachably connected to the body 100 to be convenient to detach and store when not in use. The body 100 includes a water inlet 160 and a water outlet 170 connected to the spray gun 200. The water inlet 160 is connected to an external water source. By use of a power unit 120, the external water source is introduced through the water inlet 160, and water is sprayed out through the water outlet 170 and the spray gun 200 connected to the water outlet.

The spray gun 200 includes a gun handle 210, a gun wand 220, and a nozzle 300. The gun handle 210 is detachably connected to the gun wand 220 so that the spray gun 200 can be stored in parts, saving space and facilitating a decrease in the overall volume. The spray gun 200 is used in two manners. In one manner, the gun handle 210 is not connected to the gun wand 220, and the gun handle 210 is directly connected to the nozzle 300. In this case, the spray gun 200 may be used as a short gun. In the other manner, the gun handle 210 and the gun wand 220 are assembled, and the gun wand 220 is connected to the nozzle 300. In this case, the spray gun 200 may be used as a long gun. The short gun may be equipped with a special nozzle 300 for direct water washing, and the long gun may be equipped with a high-pressure nozzle 300 for pressure washing.

The body 100 includes a housing 110, and the bottom of the housing 110 forms a base 113. The nozzle 300 is disposed on the base 113 so that space on the base 113 is fully utilized, and a support structure for the nozzle 300 is not required to be separately disposed, thereby reducing a cost and the volume. In some examples, after being detached, the nozzle 300 may be stored in a nozzle storage portion 301 on the body 100, saving storage space and preventing a loss. The nozzle 300 comes in different models. To make it convenient to place and take the nozzle 300, nozzles 300 of different models may be placed in storage holes of corresponding nozzle storage portions 301.

A first mounting groove 1104 and a second mounting groove 1105 are formed on the outer side of the housing 110. The first mounting groove 1104 is used for mounting the gun handle 210 not assembled with the gun wand 220. The second mounting groove 1105 is used for mounting the gun wand 220 not assembled with the gun handle 210. The second mounting groove 1105 is also used for mounting the spray gun 200 after the gun handle 210 is assembled with the gun wand 220. The first mounting groove 1104 and the second mounting groove 1105 are distributed on two opposite sides of the housing 110 to make full use of space.

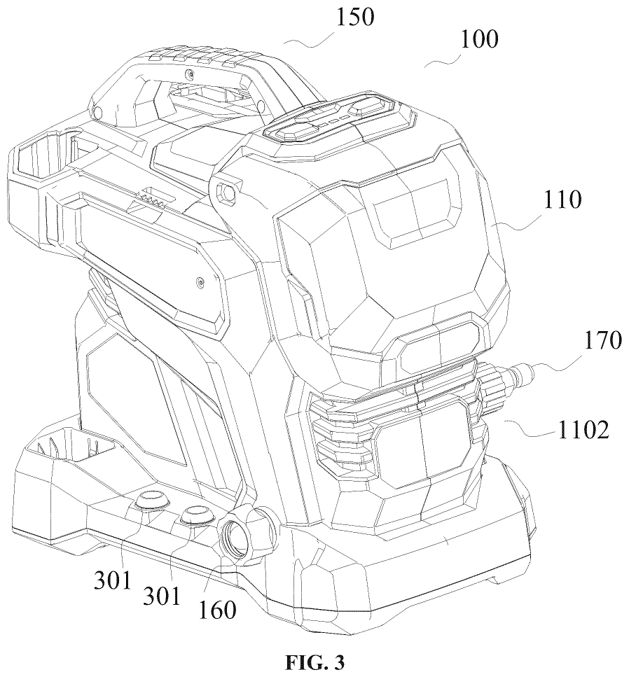

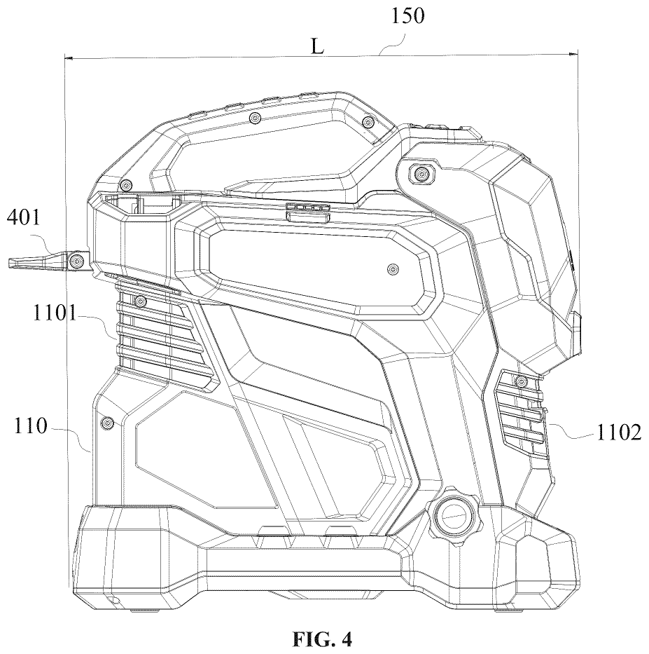

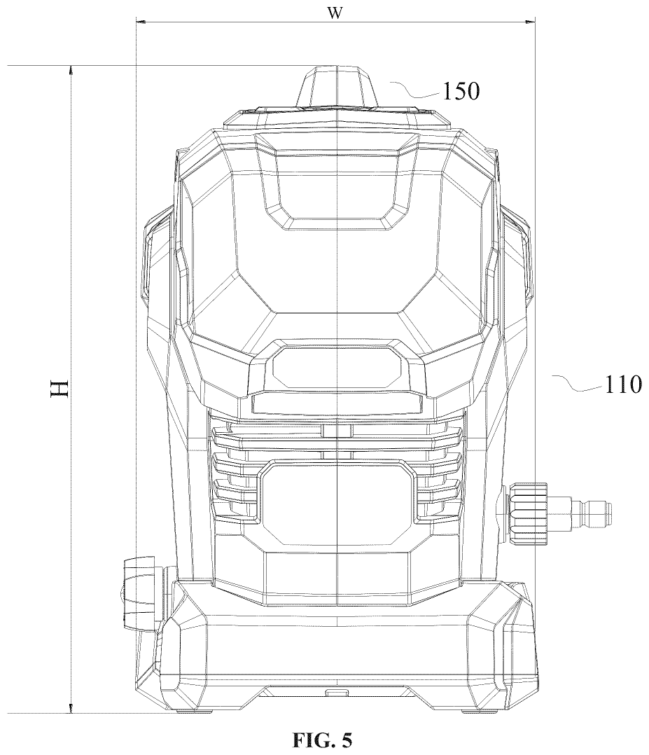

Referring to FIGS. 3 to 5, a length direction, width direction, and height direction of the body 100 are defined. L represents the length of the body 100, W represents the width of the body 100, and H represents the height of the body 100.

In some examples, the length L of the body 100 is 30 cm to 38 cm. In some examples, the length L of the body 100 is 32 cm to 38 cm. In some examples, the length of the body 100 is 30 cm, 31 cm, 32 cm, 33 cm, 34 cm, 35 cm, 36 cm, 37 cm, or 38 cm.

In some examples, the width W of the body 100 is 23 cm to 28 cm. In some examples, the width W of the body 100 is 24 cm to 28 cm. In some examples, the width W of the body 100 is 23 cm, 24 cm, 25 cm, 26 cm, 27 cm, or 28 cm.

In some examples, the height H of the body 100 is less than or equal to 40 cm. In some examples, the height H of the body 100 is less than or equal to 38 cm. In some examples, the height H of the body 100 is 32 cm to 38 cm. In some examples, the height H of the body 100 is 40 cm, 39.5 cm, 39 cm, 38.5 cm, 38 cm, 37.5 cm, 37 cm, 36.5 cm, 36 cm, 35.5 cm, or 35 cm.

In some examples, the volume of the body 100 is less than or equal to 0.032 m³. The body 100 is relatively small in volume, occupies a relatively small space, and is convenient to transport and store. In some examples, the volume of the body 100 is less than or equal to 0.03 m³. In some examples, the volume of the body 100 is 0.032 m³, 0.03 m³, 0.028 m³, 0.027 m³, 0.026 m³, 0.025 m³, or 0.024 m³.

When the pressure washing apparatus is in operation, a maximum value of a product of the pressure and the flow rate of a liquid sprayed from the spray gun 200 is greater than or equal to 2000 PSI·GPM. In the case where a relatively small volume of the body 100 is ensured, a relatively strong spraying ability can be achieved. In some examples, the maximum value of the product of the pressure and the flow rate of the liquid sprayed from the spray gun 200 is greater than or equal to 2500 PSI·GPM. In some examples, the maximum value of the product of the pressure and the flow rate of the liquid sprayed from the spray gun 200 is greater than or equal to 3000 PSI·GPM, 3500 PSI·GPM, 4000 PSI·GPM, 4500 PSI·GPM, or 5000 PSI·GPM. It is to be noted that the maximum value of the product of the pressure and the flow rate should be understood as a maximum value in the case where different nozzles are adapted rather than a maximum value for a particular nozzle. The pressure is measured in pounds per square inch (PSI). The flow rate is measured in gallons per minute (GPM).

The pressure of the liquid sprayed from the spray gun 200 is 1000 PSI to 2000 PSI. In some examples, the pressure of the liquid sprayed from the spray gun 200 is 1200 PSI to 1800 PSI. In some examples, the pressure of the liquid sprayed from the spray gun 200 is 1000 PSI, 1100 PSI, 1200 PSI, 1300 PSI, 1400 PSI, 1500 PSI, 1600 PSI, 1700 PSI, 1800 PSI, or 2000 PSI.

The flow rate of the liquid sprayed from the spray gun 200 is 0.9 GPM to 2.0 GPM. In some examples, the flow rate of the liquid sprayed from the spray gun 200 is 1.0 GPM to 1.8 GPM. In some examples, the flow rate of the liquid sprayed from the spray gun 200 is 0.9 GPM, 1.0 GPM, 1.1 GPM, 1.2 GPM, 1.3 GPM, 1.4 GPM, 1.5 GPM, 1.6 GPM, 1.7 GPM, 1.8 GPM, 1.9 GPM, or 2.0 GPM.

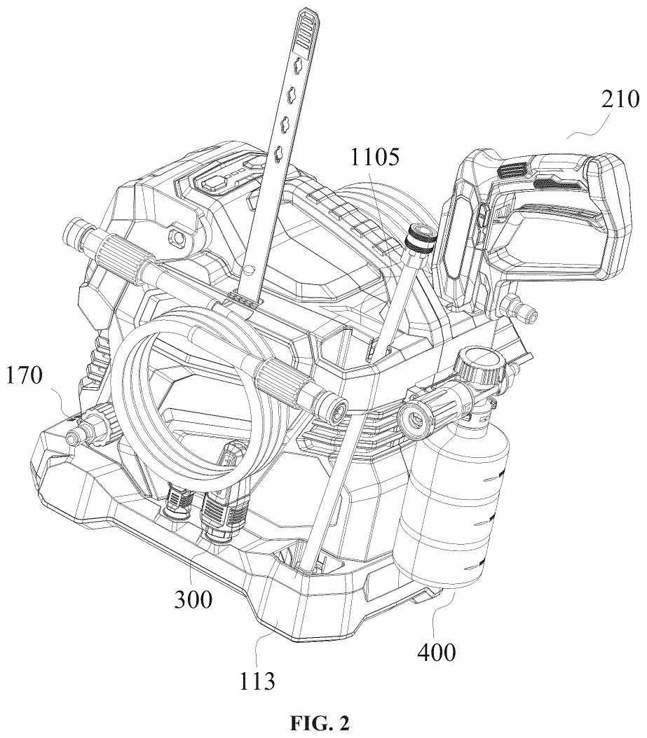

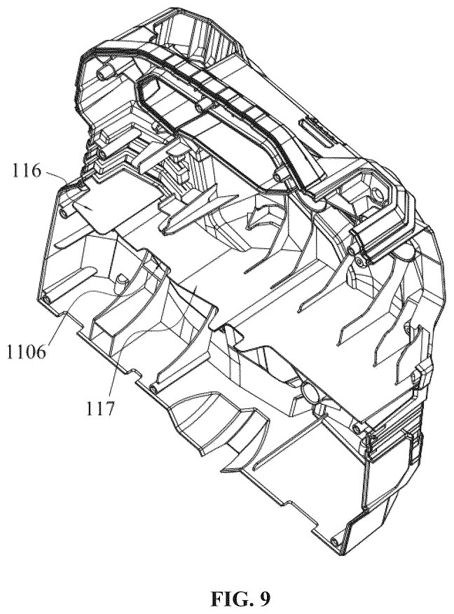

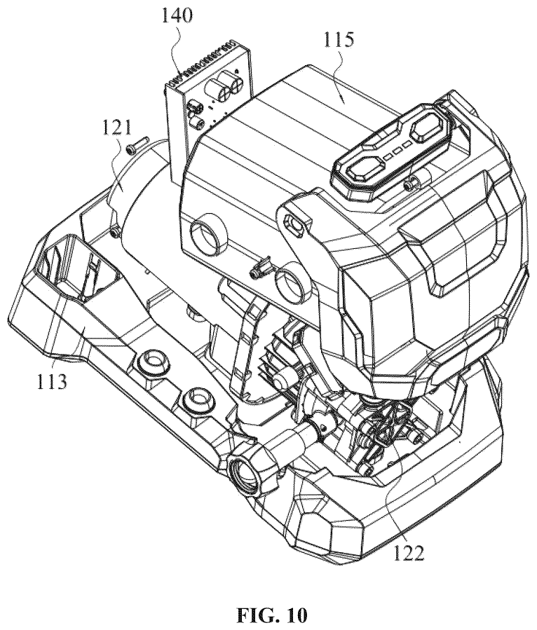

Referring to FIGS. 2 and 6 to 10, the body 100 further includes the power unit 120 and a power supply device 130. The power unit 120 includes an electric motor 121 for making the spray gun 200 spray the liquid. The power unit 120 further includes a booster pump 122 connected to the electric motor 121, and the electric motor 121 drives the booster pump 122 to operate to make the spray gun 200 spray a high-pressure liquid. The power supply device 130 includes at least one battery pack 131 to power the electric motor 121. A battery compartment 115 and a drive compartment are disposed in the housing 110, the battery pack 131 is accommodated in the battery compartment 115, and the power unit 120 is accommodated in the drive compartment.

The body 100 is defined as an outer contour of the housing including the battery pack 131. Therefore, the length of the body 100 is the length of the outer contour of the housing, the width of the body 100 is the width of the outer contour of the housing, and the height of the body 100 is the height of the outer contour of the housing. It is to be noted that the height of the body 100 should include a handle.

The pressure washing apparatus further includes a liquid tank 400 for holding a washing liquid. The liquid tank 400 is disposed outside the housing 110, thereby reducing the volume of the body 100 and facilitating mounting and removal.

The body 100 includes a support bracket 401 disposed on the outer side of the housing 110. The liquid tank 400 is detachably connected to the support bracket 401. The support bracket 401 is foldable and convenient to store and use.

An end of the electric motor 121 is connected to the booster pump 122, the other end of the electric motor 121 is connected to a cooling fan 123, and the cooling fan 123 can guide an airflow to flow, so as to cool the electric motor 121.

The body 100 further includes a circuit board assembly 140, the housing 110 is provided with an air inlet 1101 and an air outlet 1102, a heat dissipation air path 1103 for guiding the airflow to flow from the air inlet 1101 to the air outlet 1102 is formed in the housing 110, and the circuit board assembly 140 is disposed in the housing 110 and located on an airflow path of the heat dissipation air path 1103. When the pressure washing apparatus is in operation, the cooling fan 123 rotates to guide the airflow to flow along the heat dissipation air path 1103, cooling the circuit board assembly 140.

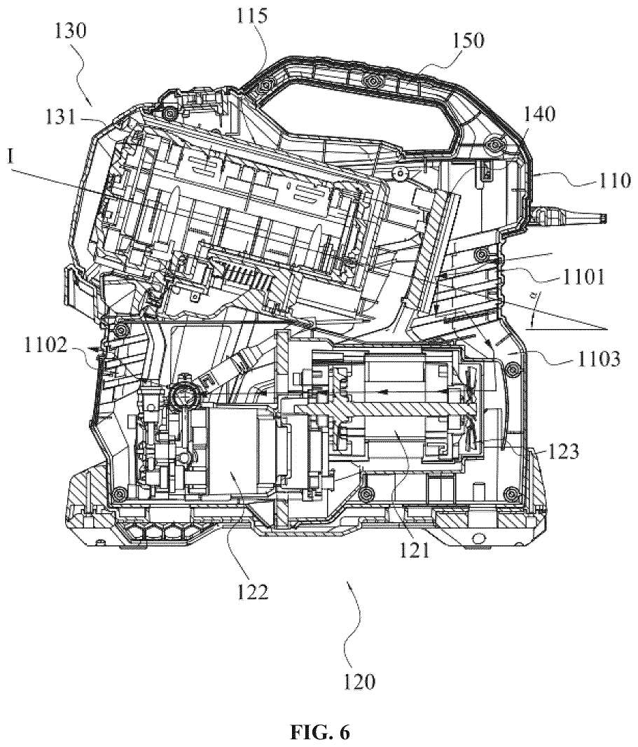

The circuit board assembly 140 is disposed close to the air inlet 1101, and the airflow entering from the air inlet 1101 flows through the circuit board assembly 140 and the electric motor 121 in sequence and then flows out from the air outlet 1102. That is, the heat dissipation air path 1103 can cool both the circuit board assembly 140 and the electric motor 121. Arrows in FIG. 6 show a flow direction of the airflow.

Referring to FIG. 6, the electric motor 121 is located below the circuit board assembly 140, the battery pack 131 is located above the booster pump 122, and the circuit board assembly 140 and the battery pack 131 are spaced along the length direction of the housing 110 in an upper portion of the housing 110. The electric motor 121, the battery pack 131, the circuit board assembly 140, and the booster pump 122 are distributed at such positions that the structure is compact and the volume is reduced as much as possible.

The air inlet 1101 is opened on a side of the circuit board assembly 140 facing away from the battery pack 131, and the air outlet 1102 is opened below the battery pack 131. That is, the air inlet 1101 and the air outlet 1102 are distributed on two opposite sides of the housing 110, increasing the length of the heat dissipation air path 1103 and extending a flow path of the airflow.

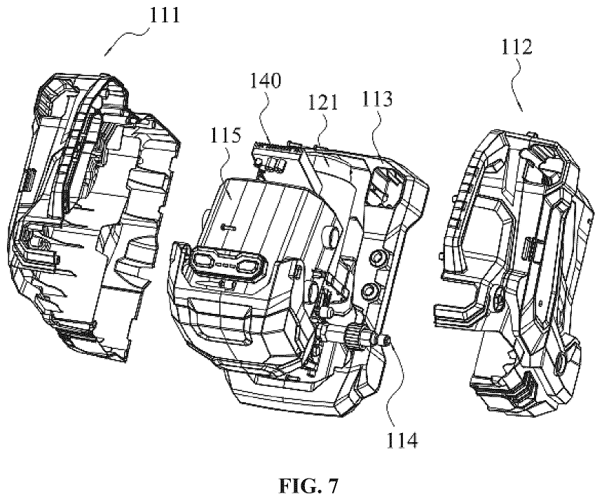

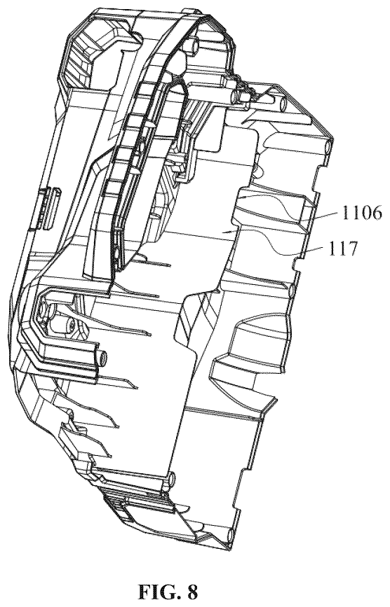

During use, water may be sucked in from the air inlet 1101. To prevent water from directly entering the electric motor 121, referring to FIGS. 7 and 8, a water stop rib 116 is disposed in the housing 110, and the water stop rib 116 blocks water and can guide the water to flow, to prevent water from entering the electric motor 121. The body 100 further includes a drain opening 1106 to facilitate water drainage.

A partition 117 is disposed between the electric motor 121 and the circuit board assembly 140, the water stop rib 116 is disposed above the partition 117, the water stop rib 116 guides water to flow onto the partition 117, and the drain opening 1106 is opened on the partition 117. A housing on an air intake side of the electric motor 121 blocks water and guides the water to flow to the bottom of the electric motor 121. The base 113 of the housing 110 is located at the bottom of the electric motor 121, and a drain opening 1106 is disposed on the base 113, enabling water to be leaked out from the bottom.

The housing 110 includes a first housing 111 and a second housing 112 that are detachable, and the first housing 111, the second housing 112, and the base 113 enclose the drive compartment capable of accommodating the power unit 120. Each of the first housing 111 and the second housing 112 is provided with the partition 117, and two partitions 117 are snap-fit to form the drain opening 1106.

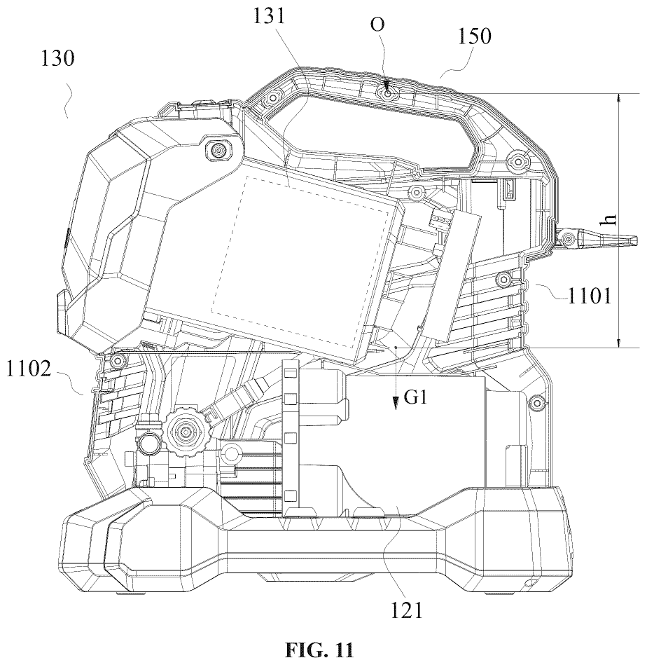

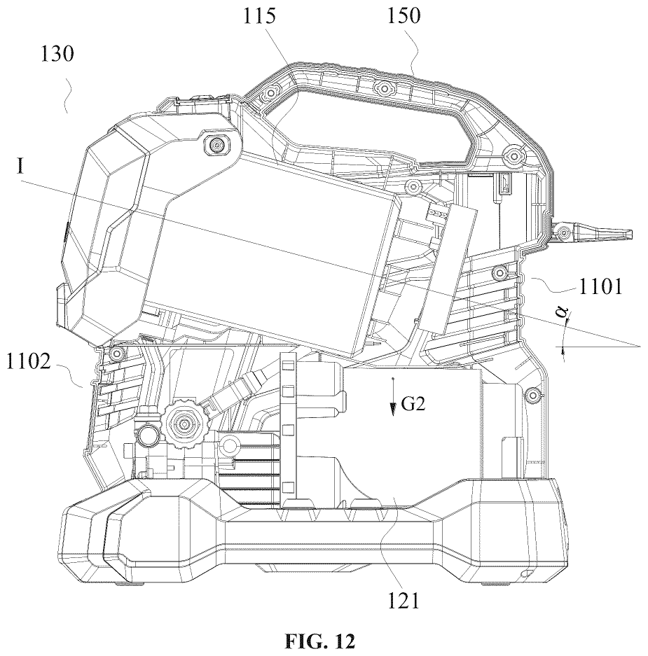

Referring to FIGS. 6, 11, and 12, the battery pack 131 is detachably inserted into the housing 110 to be convenient to mount and detach. The battery compartment 115 is disposed in the housing 110. A dashed line in FIG. 11 represents the battery pack. The battery pack 131 is accommodated in the battery compartment 115, and a mounting opening for inserting and removing the battery pack 131 is formed at an end of the battery compartment 115.

The angle α between a direction in which the battery pack 131 is inserted and removed and a horizontal or vertical plane is less than or equal to 30°. The battery pack 131 is inserted obliquely so that the overall volume is reduced, the body and the battery pack 131 can be effectively prevented from sliding during the insertion of the battery pack by the user, and the battery pack 131 is convenient to insert and remove, saving effects. It is to be understood that during the insertion of the battery pack by the user, a cover of the battery compartment is opened by one hand, and the battery pack is held by the other hand to be inserted. If the battery pack is inserted horizontally, a force along an insertion direction acts on the body, causing the body to slide. The battery pack is inserted obliquely in the present application so that the body can be effectively prevented from sliding during the insertion of the battery pack.

The battery pack 131 is detachably inserted into the housing 110 along a first direction I, where the angle α between the first direction I and the horizontal or vertical plane is less than or equal to 30°. In some examples, the angle α between the first direction I and the horizontal or vertical plane is greater than or equal to 10° and less than or equal to 30°. In some examples, the angle α between the first direction I and the horizontal or vertical plane is greater than or equal to 15° and less than or equal to 20°. In some examples, the angle α between the first direction I and the horizontal or vertical plane is 10°, 12°, 15°, 18°, 20°, 22°, 25°, 28°, or 30°.

After the battery pack 131 is inserted, the center of gravity of the body 100 is a first center of gravity. After the battery pack 131 is removed, the center of gravity of the body 100 is a second center of gravity. The distance between the first center of gravity and the second center of gravity is less than or equal to 2 cm. This ensures that after the battery pack 131 is mounted or detached, a change in the center of gravity of the body 100 is relatively small so that the body 100 is convenient for the user to lift up. G1 represents the first center of gravity, G2 represents the second center of gravity, and the distance between the first center of gravity and the second center of gravity is the length of a line between two points G1 and G2, where the line may extend vertically, horizontally, or obliquely.

In some examples, the distance between the first center of gravity and the second center of gravity is less than or equal to 1.8 cm. In some examples, the distance between the first center of gravity and the second center of gravity is 2 cm, 1.9 cm, 1.8 cm, 1.7 cm, 1.6 cm, or 1.5 cm.

The rated voltage of the battery pack 131 is 20 V to 60 V. In some examples, the rated voltage of the battery pack 131 is 30 V to 60 V. In some examples, the rated voltage of the battery pack 131 is 20 V, 25 V, 30 V, 35 V, 40 V, 45 V, 50 V, 56 V, or 60 V.

When the product of the pressure and the flow rate of the liquid sprayed from the spray gun 200 has the maximum value, a battery life of the battery pack 131 with a capacity of 336 W·h is greater than or equal to 10 minutes. A relatively long battery life can satisfy multiple usage scenarios.

After the battery pack 131 is detached, the weight of the body 100 is less than or equal to 8 kg. In some examples, the weight of the body 100 is less than or equal to 7 kg. In some examples, the weight of the body 100 is less than or equal to 6 kg. In some examples, the weight of the body 100 is 6 kg, 6.5 kg, 7 kg, 7.5 kg, or 8 kg.

An existing washing apparatus includes pull rods and wheels. The pull rods are disposed on a side of the body 100, and the wheels are disposed at the bottom of the body 100. The pull rods can be extended or retracted, and the pull rods are pushed to drive the body 100 to move with the wheels. The pressure washing apparatus of the present application has the pull rods and the wheels omitted, reducing the overall volume.

The body 100 further includes a grip 150 for the user to hold to carry and move the pressure washing apparatus. The grip 150 is disposed so that the overall height is reduced, and the pressure washing apparatus is convenient to carry and move and can be easily stored in a trunk of a car.

The grip 150 is disposed at the top of the housing 110 and extends along a long side of the top of the housing 110, and the grip 150 extends from an end of the housing 110 to the other end of the housing 110. The grip 150 is located at the top of the housing 110 and extends along a length direction of the top, so as to improve the center of gravity of the body 100.

The grip 150 serves as part of the housing 110 or is connected to the housing 110. The height of the body 100 includes the grip 150. Along the height direction, the distance from the grip 150 to the bottom of the pressure washing apparatus is less than or equal to 40 cm.

An outer surface of at least part of the grip 150 is covered with a flexible layer to provide a stable grip position, increase friction, and reduce slipping.

The length of the grip 150 is greater than or equal to 15 cm. In some examples, the length of the grip 150 is 15 cm, 16 cm, 17 cm, 18 cm, 19 cm, 20 cm, 21 cm, 22 cm, 23 cm, 24 cm, or 25 cm.

An effective grip length of the grip 150 is greater than or equal to 10 cm. The grip extends a certain distance in the length direction, so as to improve the center of gravity of the body 100. In some examples, the effective grip length of the grip 150 is greater than or equal to 15 cm. In some examples, the effective grip length of the grip 150 is 10 cm, 11 cm, 12 cm, 13 cm, 14 cm, 15 cm, 16 cm, 17 cm, 18 cm, 19 cm, or 20 cm.

In the height direction, the distance from the grip center O of the grip 150 to the center of gravity of the body 100 is less than or equal to 30 cm. Not only is carrying facilitated, but also the structure is compact and the volume is reduced. Referring to FIG. 11, O represents the grip center of the grip 150, G1 represents the center of gravity of the body 100, and h represents the distance from the grip center O of the grip 150 to the center of gravity G1 of the body 100 in the height direction. The center of gravity of the body 100 should be understood as a center of gravity when the washing liquid is excluded.

In some examples, in the height direction, the distance from the grip center O of the grip 150 to the center of gravity G1 of the body 100 is less than or equal to 28 cm. In some examples, in the height direction, the distance from the grip center O of the grip 150 to the center of gravity G1 of the body 100 is less than or equal to 25 cm. In some examples, in the height direction, the distance from the grip center O of the grip 150 to the center of gravity G1 of the body 100 is 20 cm, 21 cm, 22 cm, 23 cm, 24 cm, 25 cm, 26 cm, 27 cm, 28 cm, 29 cm, or 30 cm.

For example, the body 100 has a length of 36 cm, a width of 24 cm, and a height of 36.5 cm. After the battery pack 131 is detached, the weight of the body 100 is 6.4 kg. The power of the electric motor 121 is 1400 W. The length of the grip 150 is 21.5 cm, and the effective grip length of the grip 150 is 15 cm. The rated voltage of the battery pack 131 is 56 V.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A pressure washing apparatus, comprising:
a body; and
a spray gun connectable to the body;
wherein the body comprises:
a housing;
a power unit, located in the housing, comprising an electric motor for making the spray gun spray a liquid;
a power supply device comprising at least one battery pack to power the electric motor; and
a grip for a user to hold to carry and move the pressure washing apparatus; and
wherein, when the pressure washing apparatus is in operation, a maximum value of a product of pressure and a flow rate of the liquid sprayed from the spray gun is greater than or equal to 2000 PSI·GPM; and a volume of the body is less than or equal to 0.032 m³.

2. The pressure washing apparatus according to claim 1, wherein the maximum value of the product of the pressure and the flow rate of the liquid sprayed from the spray gun is greater than or equal to 2500 PSI·GPM.

3. The pressure washing apparatus according to claim 1, wherein the volume of the body is less than or equal to 0.03 m³.

4. The pressure washing apparatus according to claim 1, wherein the pressure of the liquid sprayed from the spray gun is 1000 PSI to 2000 PSI.

5. The pressure washing apparatus according to claim 1, wherein the flow rate of the liquid sprayed from the spray gun is 0.9 GPM to 2.0 GPM.

6. The pressure washing apparatus according to claim 1, wherein the grip is disposed at a top of the housing and extends along a long side of the top of the housing, and the grip extends from an end of the housing to another end of the housing.

7. The pressure washing apparatus according to claim 1, wherein a length L of the body is greater than or equal to 30 cm and less than or equal to 38 cm.

8. The pressure washing apparatus according to claim 1, wherein a height H of the body is greater than or equal to 32 cm and less than or equal to 38 cm.

9. The pressure washing apparatus according to claim 1, wherein a width W of the body is greater than or equal to 23 cm and less than or equal to 28 cm.

10. The pressure washing apparatus according to claim 1, wherein the at least one battery pack is detachably inserted into the housing, and a rated voltage of each of the at least one battery pack is 20 V to 60 V.

11. The pressure washing apparatus according to claim 1, wherein, when the product of the pressure and the flow rate of the liquid sprayed from the spray gun reaches the maximum value, a battery life of the at least one battery pack with a capacity of 336 W·h is greater than or equal to 10 minutes.

12. The pressure washing apparatus according to claim 1, further comprising a liquid tank, wherein the housing has a water inlet, and the liquid tank is disposed outside the housing and supplies water to the spray gun through the water inlet.

13. The pressure washing apparatus according to claim 1, wherein the body further comprises a circuit board assembly, the housing is provided with an air inlet and an air outlet, a heat dissipation air path for guiding an airflow to flow from the air inlet to the air outlet is formed in the housing, and the circuit board assembly is disposed in the housing and located on an airflow path of the heat dissipation air path.

14. The pressure washing apparatus according to claim 13, wherein the circuit board assembly is disposed close to the air inlet, and the airflow entering from the air inlet flows through the circuit board assembly and the electric motor in sequence and then flows out from the air outlet.

15. The pressure washing apparatus according to claim 1, wherein the power unit further comprises a booster pump connected to the electric motor, and the electric motor drives the booster pump to operate to make the spray gun spray a high-pressure liquid.

16. A pressure washing apparatus, comprising:
a body; and
a spray gun connectable to the body;
wherein the body comprises:
a housing;
a power unit, located in the housing, comprising an electric motor for making the spray gun spray a liquid;
a power supply device comprising at least one battery pack to power the electric motor; and
a grip for a user to hold to carry and move the pressure washing apparatus; and
wherein, when the pressure washing apparatus is in operation, a maximum value of a product of pressure and a flow rate of the liquid sprayed from the spray gun is greater than or equal to 2000 PSI·GPM; and a height of the body is less than or equal to 40 cm.

17. The pressure washing apparatus according to claim 16, wherein the at least one battery pack is detachably inserted into the housing, an angle α between a direction in which the at least one battery pack is inserted and detached and a horizontal or vertical plane is less than or equal to 30°, and, after the at least one battery pack is detached, a weight of the body is less than or equal to 8 kg.

18. A pressure washing apparatus, comprising:
a body; and
a spray gun connectable to the body;
wherein the body comprises:
a housing;
a power unit, located in the housing, comprising an electric motor for making the spray gun spray a liquid; and
a power supply device comprising at least one battery pack to power the electric motor; and
wherein, when the pressure washing apparatus is in operation, a maximum value of a product of pressure and a flow rate of the liquid sprayed from the spray gun is greater than or equal to 2000 PSI·GPM; the housing is formed with or connected to a grip for a user to hold to carry and move the pressure washing apparatus; and in a height direction, a distance from a grip center of the grip to a center of gravity of the body is less than or equal to 30 cm.

19. The pressure washing apparatus according to claim 18, wherein the grip is disposed at a top of the housing and extends along a long side of the top of the housing, and the grip extends from an end of the housing to another end of the housing.

20. The pressure washing apparatus according to claim 18, wherein the at least one battery pack is detachably inserted into the housing and a distance between a first center of gravity of the body, defined when the at least one battery pack is inserted into the housing, and a second center of gravity of the body, defined when the at least one battery pack is removed from the housing, is less than or equal to 2 cm.
